(19) United States
(12) Patent Application Publication
(10) Pub. No.: US 2008/0189846 A1
(43) Pub. Date: Aug. 14, 2008

(54) Diverter Valve System for a Spa and a Spa Incorporating Same

(76) Inventor: W. John Gardenier, Wallingford, CT (US)

Correspondence Address: GORDON & JACOBSON, P.C., 60 LONG RIDGE ROAD, SUITE 407, STAMFORD, CT, 06902, US

(21) Appl. No.: 12/038,056

(22) Filed: Feb. 27, 2008

Related U.S. Application Data
(63) Continuation of application No. 11/098,061, filed on Apr. 4, 2005, now abandoned.

(51) Int. Cl. A61H 33/00; F16K 11/085

(52) U.S. Cl. 4/541.3; 4/541.6; 4/541.1; 137/625.47

(57) ABSTRACT

A valve system for a spa includes a jet manifold which is coupled to all of the water jets associated with a seat in the spa and which is coupled to an individual water pump for the seat. A T-fitting is interposed between the manifold and the pump. A conduit is coupled from the T-fitting to a valve which is coupled to a suction fitting in the bottom of the spa. When the valve is opened, water is diverted from the manifold thereby reducing the volume of water supplied to the jets and thus reducing the pressure of the water streams at the associated seat without affecting the water pressure at other seats. A spa according to the invention includes a plurality of seats, each associated with a group of water jets, each group of jets being coupled to a valve system with an associated pump.

### RELATED APPLICATIONS

This application is a continuation of U.S. Ser. No. 11/098,061, filed Apr. 4, 2005, which is hereby incorporated by reference herein in its entirety.

### BACKGROUND OF THE INVENTION

1. Field of the Invention

This invention relates broadly to spas. More particularly, this invention relates to the control of water flow to water jets in a spa.

2. State of the Art

Hydrotherapy and hydrothermal therapy have been used for many centuries and in many different cultures. Recently, hydrotherapy “spas” also known as “hot tubs” have become very popular in health clubs and even in individual homes. Prior art FIG. 1 shows an example of a state of the art spa 10. The spa 10 consists of a large tub which is dimensioned to accommodate several sitting adults with warm water up to chest height or above. Water jets are arranged in groups 14a-14d so that all of the occupants receive a water massage by virtue of the water jets directing streams of pressurized water at the bodies of the occupants. Water jets are usually arranged to massage each occupant's back, legs, arms and feet.

In most state of the art spas, each water jet is individually adjustable by twisting the jet to control the volume of water passing through it. In addition, all of the jets are adjustable together via a single master flow control. The individual adjustability of each jet is not much of an advantage to the end users. This is because there are so many jets in a modern spa that adjusting dozens of jets to accommodate the different requirements of multiple users would be very tedious and time consuming.

### SUMMARY OF THE INVENTION

It is therefore an object of the invention to provide a system for easily adjusting the flow of different banks of jets in a spa.

It is another object of the invention to provide a system for separately adjusting the group of jets at each seat in a spa.

It is a further object of the invention to provide a valve arrangement for each seat in a spa where the valve is arranged to the jets associated with the seat independent of the other jets in the spa.

It is also an object of the invention to provide a valve arrangement whereby the jets may be quickly adjusted in water pressure.

In accord with these objects, which will be discussed in detail below, the valve system of the present invention includes a jet manifold which is coupled to all of the water jets associated with a seat in the spa and which is coupled to an individual water pump for the seat. A T-fitting is interposed between the manifold and the pump. A first water conduit is coupled from the T-fitting to a valve which is coupled to a second conduit which extends to suction fittings in the bottom of the spa. When the valve is opened, water is diverted from the manifold thereby reducing the volume of water supplied to the jets and thus reducing the pressure of the water streams at the associated seat without affecting the water pressure at other seats. The valve preferably adjusts fluid flow from full to a trickle by rotating the valve less than 360 degrees and most preferably about 180 degrees. A spa according to the invention includes a plurality of seats, each associated with a group of water jets, each group of jets being coupled to a valve system.

Additional objects and advantages of the invention will become apparent to those skilled in the art upon reference to the detailed description taken in conjunction with the provided figures.

### BRIEF DESCRIPTION OF THE DRAWINGS

FIG. 1 is a top plan view of a prior art spa having four seats;

FIG. 2 is a broken perspective view of a portion of a spa according to the invention;

FIG. 3 is a schematic illustration of a valve system according to the invention;

FIG. 4 is an exploded schematic side view of a valve used in the assembly of the invention; and

FIG. 5 is a partially assembled schematic front view of the valve of FIG. 4.

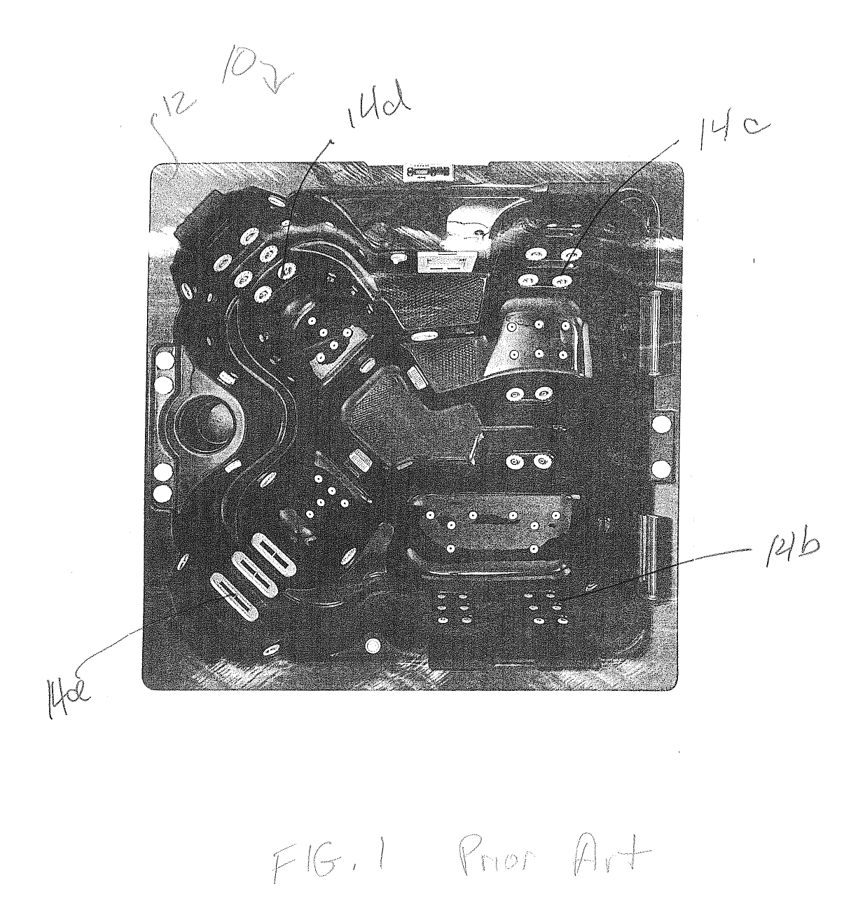

### DETAILED DESCRIPTION OF THE PREFERRED EMBODIMENTS

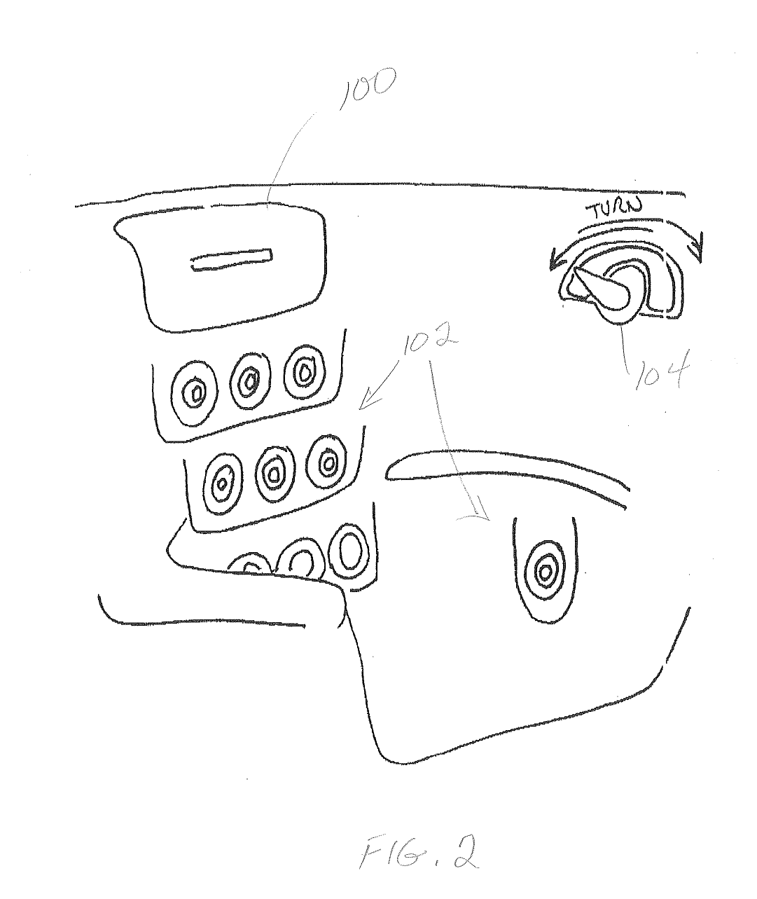

Turning now to FIG. 2, each seat 100 in a spa according to the invention has a plurality of water jets 102 associated with it, typically up to about thirty jets per seat. All of these jets are controlled by a valve 104 which is conveniently located relative to the seat. The valve 104 controls the jets 102 without affecting the jets (not shown) associated with other seats in the spa. Preferably each seat in the spa has a valve which controls the jets associated with that seat and does not interfere with the jets at the other seats, although adjacent seats and their associated jets may share a valve 104. Also according to the presently preferred embodiment, the valve 104 rotates less than 360° from fully opened to fully closed, and most preferably no more than 180°. This is highly advantageous for the convenience of the spa user.

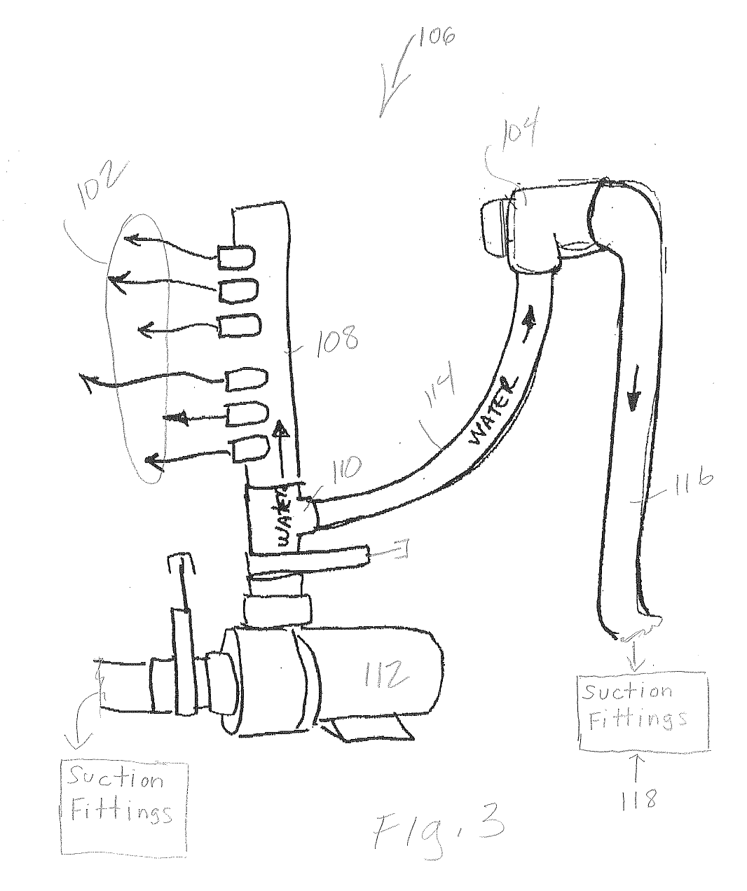

FIG. 3 is a schematic illustration of the valve system 106 according to the invention. The system includes a manifold 108 which is coupled to a bank of jets 102 which are to be controlled by the valve 104. The manifold 108 is coupled by a T-fitting 110 to the outlet of a pump 112 dedicated to the group of jets 102 and the valve 104. The third coupling of the T-fitting 110 is coupled to the valve 104 by a first conduit 114. The valve 104 is also coupled to the suction fittings 118 and/or a open free flowing fitting directly diffused into the bottom of the spa by a second conduit 116. From the foregoing, those skilled in the art will appreciate that when the valve 104 is closed, substantially all of the water available from the pump 112 for a bank of jets 102 is directed into the manifold 108 and out to the jets 102. As the valve 104 is opened, water is diverted away from the manifold 108 and thus less water exits the jets 102. Less water from the jets 102 means less water pressure felt by the occupant of the seat. Preferably each bank of jets in the tub (as grouped by seating location) is provided with a dedicated pump, although adjacent banks may share a pump.

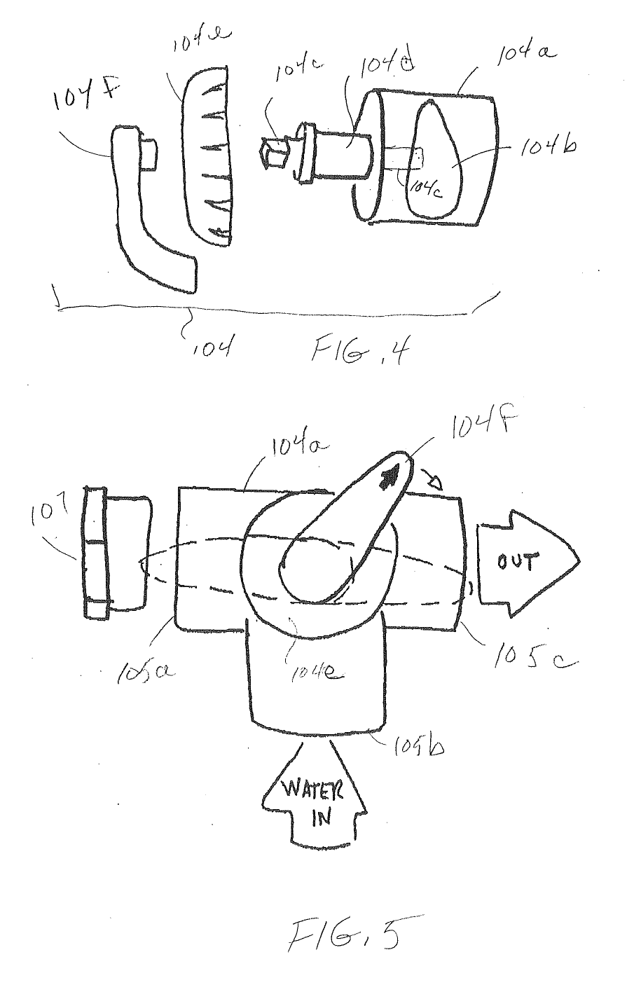

FIGS. 4 and 5 show details of a suitable valve 104 for use in the valve system. The valve 104 includes a body 104a having three couplings 105a, 105b, and 105c. A valve puck 104b is centrally located within the valve body 104a and is coupled to a valve stem 104c. The valve stem 104c extends through a sleeve 104d and is coupled to a valve handle 104f. A cover plate 104e is preferably interposed between the handle 104f and the sleeve 104d. The coupling 105a is plugged with a plug 107. The coupling 105b is coupled to the conduit 114 (FIG. 3) and the coupling 105c is coupled to the conduit 116 (FIG. 3).

There have been described and illustrated herein a valve system for a spa and a spa incorporating same. It will therefore be appreciated by those skilled in the art that yet other modifications could be made to the provided invention without deviating from its spirit and scope as claimed.

What is claimed is:

1. A spa, comprising:
a tub;
a plurality of water jets mounted in said tub, said water jets arranged into two or more groups, each of said groups including a plurality of water jets;
a first pump having an outlet coupled to said one of said groups of water jets; and
a first valve coupled between said pump and said one of said groups of water jets which is arranged to divert water from said first pump outlet away from said one of said groups so as to increase or decrease water flow through said one of said groups, as a whole, without affecting water flow through any other groups of jets mounted in said tub.

2. The spa according to claim 1, wherein:
said first valve is arranged to rotate less than 360° from fully opened to fully closed.

3. The spa according to claim 2, wherein:
said first valve is arranged to rotate approximately 180° from fully opened to fully closed.

4. A spa according to claim 1, wherein:
a second valve is coupled to a second one of said groups of water jets for adjusting water flow through said second one of said groups without affecting water flow through the other groups.

5. The spa according to claim 4, further comprising:
a second pump having an outlet coupled to said second one of said groups, said second valve being arranged to divert water from said second pump outlet.

6. The spa according to claim 4, wherein:
said second valve is arranged to rotate less than 360° from fully opened to fully closed.

7. The spa according to claim 6, wherein:
said second valve is arranged to rotate approximately 180° from fully opened to fully closed.

8. The spa according to claim 1, wherein:
said tub defines a plurality of seats, and each group of water jets is associated with a separate seat.

9. In a spa system including a tub defining seat locations, a plurality of water jets mounted in the tub in several groups, a manifold coupled to one of the groups of jets, a pump dedicated to the one of the groups of jets, the manifold having an inlet for receiving a source of water from a pump, the pump having an inlet for receiving water from the tub and an outlet through which water is provided under pressure toward the manifold, the improvement comprising:
a valve coupled between the pump and the manifold such that when said valve is opened, water is diverted from the manifold to increase or decrease the pressure of the water flowing through the one of the groups of jets, as a collective whole, without affecting the water pressure flowing through any of the other groups of jets.

10. A valve system according to claim 9, wherein:
said valve is arranged to rotate less than 360° from fully opened to fully closed.

11. A valve system according to claim 9, wherein:
said valve is arranged to rotate approximately 180° from fully opened to fully closed.

12. A valve system according to claim 9, wherein:
a suction fitting coupled relative to the tub and which feeds water from said tub to said pump inlet, wherein said valve is arranged to divert water toward said suction fitting.

13. A valve system according to claim 9, wherein:
the valve is arranged to divert water into the tub.

14. A spa, comprising:
a tub having an interior;
a plurality of water jets mounted in said tub, said water jets arranged into two or more groups, each of said groups including a plurality of water jets;
a manifold coupling said jets of one of said groups together;
a pump dedicated to said one of said groups, said pump having an inlet configured to receive water from said interior of said tub and an outlet coupled to said manifold; and
a valve coupled between said pump and said manifold, said valve arranged to divert water from said pump outlet and into said tub so as to bypass all said water jets mounted in said tub.

15. A spa according to claim 14, further comprising:
a suction fitting coupled relative to the tub and which feeds water from said tub to said pump inlet, wherein said valve is arranged to divert water toward said suction fitting.

16. A spa according to claim 14, wherein:
said valve is arranged to rotate less than 360° from fully opened to fully closed.

17. A spa according to claim 14, wherein:
said valve is arranged to rotate approximately 180° from fully opened to fully closed.
